(19) United States
(12) Patent Application Publication
(10) Pub. No.: US 2021/0216211 A1
(43) Pub. Date: Jul. 15, 2021

(54) Availability Balanced Geographically Diverse Storage

(71) Applicant: EMC IP Holding Company LLC, Hopkinton, MA (US)

(72) Inventors: Mikhail Danilov, Saint Petersburg (RU); Yohannes Altaye, Dumfries, VA (US)

(21) Appl. No.: 16/743,376

(22) Filed: Jan. 15, 2020

(51) Int. Cl. G06F 3/06

(52) U.S. Cl. CPC G06F 3/065; G06F 3/067; G06F 3/0619

(57) ABSTRACT

Data storage in a geographically diverse storage system having an asymmetric computing resource topography is disclosed. Data chunks can be stored in storage devices of different zones of a zone storage system based on a predicted data accessibility metric. The data accessibility metric can be based, in part, on historic data accessibility and can therefore reflect the asymmetric computing resource topography. This availability balanced data storage can improve total data access time, by balancing storage volume in view of the accessibility resulting from the asymmetric computing resource topography, in contrast to symmetric storage of data. The availability balancing is adaptable where the predicted performance differs from measured performance.

### TECHNICAL FIELD

The disclosed subject matter relates to data storage, more particularly, to storage of data blocks among geographically diverse storage devices.

### BACKGROUND

Conventional data storage techniques can mirror data stored at a first data store at a second data store. As an example, a disk can be copied to a remotely located data store to preserve a copy of the disk. One use of data storage is in bulk data storage.

### BRIEF DESCRIPTION OF DRAWINGS

FIG. 1 is an illustration of an example system that can facilitate geographically diverse storage, in accordance with aspects of the subject disclosure.

FIG. 2 is an illustration of an example system demonstrating asymmetrically data availability, wherein the example system can facilitate geographically diverse storage, in accordance with aspects of the subject disclosure.

FIG. 3 is an illustration of an example system that can enable symmetric storage of data in an asymmetrically balanced geographically diverse storage, in accordance with aspects of the subject disclosure.

FIG. 4 illustrates an example system that can facilitate availability balanced storage of data in an asymmetrically balanced geographically diverse storage, in accordance with aspects of the subject disclosure.

FIG. 5 is an illustration of an example system that can employ a controller to facilitate availability balanced storage of data in an asymmetrically balanced geographically diverse storage, in accordance with aspects of the subject disclosure.

FIG. 6 is an illustration of an example method facilitating employing availability balanced storage of data in an asymmetrically balanced geographically diverse storage, in accordance with aspects of the subject disclosure.

FIG. 7 is an illustration of an example method facilitating determining availability balanced storage of data in an asymmetrically balanced geographically diverse storage system, in accordance with aspects of the subject disclosure.

FIG. 8 is an illustration of an example method facilitating adapting availability balanced storage of data in an asymmetrically balanced geographically diverse storage via a centralized controller, in accordance with aspects of the subject disclosure.

FIG. 9 depicts an example schematic block diagram of a computing environment with which the disclosed subject matter can interact.

FIG. 10 illustrates an example block diagram of a computing system operable to execute the disclosed systems and methods in accordance with an embodiment.

### DETAILED DESCRIPTION

The subject disclosure is now described with reference to the drawings, wherein like reference numerals are used to refer to like elements throughout. In the following description, for purposes of explanation, numerous specific details are set forth in order to provide a thorough understanding of the subject disclosure. It may be evident, however, that the subject disclosure may be practiced without these specific details. In other instances, well-known structures and devices are shown in block diagram form in order to facilitate describing the subject disclosure.

Data storage in a single location, as in many conventional systems, can risk a data loss event, for example when a drive, storage component, storage node, network connection, etc., under performs, becomes less available, becomes unavailable, is damaged, etc. As an example, data stored on a disk on a server can become less available if the drive fails, while the server reboots, where the server is down for maintenance, if a network connection to the server/drive is down, becomes slow, becomes noisy, a processor of the server/drive becomes more heavily burdened, etc. Accordingly, it can be desirable to replicate data at one or more other locations, e.g., to provide alternate access to the stored data via a replicate at another location. Conventionally, data can be mirrored at another location, e.g., a full copy of the data can be stored at one or more other locations, as an example, mirroring a local disk at a remotely located server can provide access to the mirrored disk data via the remotely located server where the data on the disk becomes locally less available. However, this can be associated with copying full data sets, full disks, etc., which can be computing resources intensive, e.g., increased network demand, increased storage space demand, increased processor demand, etc. Moreover, a single mirror itself can also become less available in some instances, resulting in the data still being less available despite the precaution taken.

As is presently disclosed, data can be stored in data containers, e.g., data chunks. A chunk can therefore provide storage for a portion of a total amount of data, e.g., the total data can be packaged among one or more chunks. In an aspect, such as in bulk data storage, chunks can be append only fixed size data containers, e.g., data can be written into chunks of a fixed size as the data is to be stored. When a chunk becomes full, e.g., as data stored in the chunk approaches the chunk size, additional data can be stored in a different chunk and the previously used chunk can be sealed. The sealed chunk can be regarded as immutable. To provide protection against data becoming less available, e.g., against a data loss event, the one or more chunks can be replicated at remotely located data storage devices. In an aspect, the storage devices can be allocated among different geographical areas or zones, e.g., a first zone storage component (ZSC) can comprise data storage devices for a first geographical area, while a second zone storage component can comprise data storage devices for a second geographical area, etc.

In an aspect, several zones can be comprised in a geographically diverse data storage system to provide increased resiliency against a data loss event. As an example, a geographically diverse data storage system can comprise three zones, e.g., three ZSCs, in three different geographical areas. The three ZSCs can each store local chunks and can also store copies of remote chunks from other zones. As an example, a first ZSC can store two local chunks and a second ZSC can store a replicate of one or the first ZSC local chunks while a third ZSC can store a replicate of the other first ZSC local chunk. As such, in this example, if the first ZSC becomes less available, the data can be accessed via the replicates at the second and third ZSCs. Moreover, in this example, if both the first and second ZSC become less available, a portion of the data can still be accessible via the replicated chunk at the third ZSC. As the number of ZSCs increases, it can be appreciated that the distribution of replicated chunks can provide increased data access in comparison to simply mirroring all the data from one ZSC to one other ZSC. One use of geographically diverse data storage can be in bulk data storage.

Geographically diverse data storage can provide advantages to bulk data storage, which can include networked storage, e.g., cloud storage, for example Elastic Cloud Storage offered by Dell EMC, because data chunks can comprise data from one or more different bulk storage customers in an efficient manner that can still provide data redundancy. Bulk storage can, in an aspect, manage disk capacity via partitioning of disk space into blocks of fixed size, e.g., chunks, for example a 128 MB chunk, etc. Chunks can be used to store user data, and the chunks can be shared among the same or different users, for example, one chunk may contain fragments of several user objects. A chunk's content can generally be modified in an append-only mode to prevent overwriting of data already added to the chunk. As such, when a typical chunk becomes full enough, it can be sealed so that the data therein is generally not able for further modification. These chunks can be then stored in a geographically diverse manner to allow for recovery of the data where a first copy of the data is destroyed, e.g., disaster recovery, etc. Blocks of data, hereinafter ‘data chunks’, or simply ‘chunks’, can be used to store user(s) data. Chunks can be shared among the same or different users, e.g., a typical chunk can contain fragments of different user data objects. As such, for a typical append-only chunk that is determined to be full, the data therein is generally not able to be further modified. Eventually the chunk can be stored/replicated ‘off-site’, e.g., in a geographically diverse manner, to provide for disaster recovery, etc. Chunks from a data storage device, e.g., ‘zone storage component’, ‘zone storage device’, etc., located in a first geographic location, hereinafter a ‘zone’, etc., can be stored in a second zone storage device that is located at a second geographic location different from the first geographic location. This can enable recovery of data where the first zone storage device is damaged, destroyed, offline, etc., e.g., disaster recovery of data, by accessing the off-site data from the second zone storage device.

In an aspect, it is noted that data storage techniques can employ convolution and deconvolution, compression, etc., to conserve storage space. As an example, convolution can allow data to be packed or hashed in a manner that uses less space that the original data. Moreover, convolved data, e.g., a convolution of first data and second data, etc., can typically be de-convolved to the original first data and second data. As an example, a storage device in Topeka can store a backup of data from a first zone storage device in Houston, e.g., Topeka can be considered geographically diverse from Houston. As a second example, data chunks from Seattle and San Jose can be stored in Denver. The example Denver storage can be compressed or uncompressed, wherein uncompressed indicates that the Seattle and San Jose chunks are replicated in Denver, and wherein compressed indicates that the Seattle and San Jose chunks are convolved, for example via an ‘XOR’ operation, into a different chunk to allow recovery of the Seattle or San Jose data from the convolved chunk, but where the convolved chunk typically consumes less storage space than the sum of the storage space for both the Seattle and San Jose chunks individually. In an aspect, compression can comprise convolving data and decompression can comprise deconvolving data, hereinafter the terms compress, compression, convolve, convolving, etc., can be employed interchangeably unless explicitly or implicitly contraindicated, and similarly, decompress, decompression, deconvolve, deconvolving, etc., can be used interchangeably. Compression, therefore, can allow original data to be recovered from a compressed chunk that consumes less storage space than storage of the uncompressed data chunks. This can be beneficial in that data from a location can be backed up by redundant data in another location via a compressed chunk, wherein a redundant data chunk can be smaller than the sum of the data chunks contributing to the compressed chunk. As such, local chunks, e.g., chunks from different zone storage devices, can be compressed via a convolution technique to reduce the amount of storage space used by a compressed chunk at a geographically distinct location.

In an embodiment, a convolved chunk stored at a geographically diverse storage device can comprise data from all storage devices of a geographically diverse storage system. As an example, where there are five storage devices, a first storage device can convolve chunks from the other four storage devices to create a ‘backup’ of the data from the other four storage devices. In this example, the first storage device can create a backup chunk from chunks received from the other four storage devices. In an aspect, this can result in generating copies of the four received chunks at the first storage device and then convolving the four chunks to generate a fifth chunk that is a backup of the other four chunks. Moreover, one or more other copies of the four chunks can be created at the first storage device for redundancy, for example if each chunk has two redundant chunks created, then the four received chunks and their redundant copies results in creating 12 chunks at the first storage device before creating the convolved chunk that is then also redundantly copied resulting in 15 chunk creation events. Further, the 12 redundant copies of the four received chunks is then deleted, e.g., the storage space is released for reuse, the corresponding storage space is overwritten and released, etc., leaving just the convolved chunk and related redundant copies thereof.

In an aspect, the presently disclosed subject matter can include ‘zones’. A zone can correspond to a geographic location or region. As such, different zones can be associated with different geographic locations or regions. As an example, Zone A can comprise Seattle, Wash., Zone B can comprise Dallas, Tex., and, Zone C can comprise Boston, Mass. In this example, where a local chunk from Zone A is replicated, e.g., compressed or uncompressed, in Zone C, an earthquake in Seattle can be less likely to damage the replicated data in Boston. Moreover, a local chunk from Dallas can be convolved with the local Seattle chunk, which can result in a compressed/convolved chunk, e.g., a partial or complete chunk, which can be stored in Boston. As such, either the local chunk from Seattle or Dallas can be used to de-convolve the partial/complete chunk stored in Boston to recover the full set of both the Seattle and Dallas local data chunks. The convolved Boston chunk can consume less disk space than the sum of the Seattle and Dallas local chunks. An example technique can be “exclusive or” convolution, hereinafter ‘XOR’, ‘⊕’, etc., where the data in the Seattle and Dallas local chunks can be convolved by XOR processes to form the Boston chunk, e.g., C=A1 ⊕ B1, where A1 is a replica of the Seattle local chunk, B1 is a replica of the Dallas local chunk, and C is the convolution of A1 and B1. Of further note, the disclosed subject matter can further be employed in more or fewer zones, in zones that are the same or different than other zones, in zones that are more or less geographically diverse, etc. As an example, the disclosed subject matter can be applied to data of a single disk, memory, drive, data storage device, etc., without departing from the scope of the disclosure, e.g., the zones represent different logical areas of the single disk, memory, drive, data storage device, etc. Moreover, it will be noted that convolved chunks can be further convolved with other data, e.g., D=C1 ⊕E1, etc., where E1 is a replica of, for example, a Miami local chunk, E, C1 is a replica of the Boston partial chunk, C, from the previous example and D is an XOR of C1 and E1 located, for example, in Fargo.

In an aspect, XORs of data chunks in disparate geographic locations can provide for de-convolution of the XOR data chunk to regenerate the input data chunk data. Continuing a previous example, the Fargo chunk, D, can be de-convolved into C1 and E1 based on either C1 or D1; the Miami chunk, C, can be de-convolved into A1 or B1 based on either A1 or B1; etc. Where convolving data into C or D comprises deletion of the replicas that were convolved, e.g., A1 and B1, or C1 and E1, respectively, to avoid storing both the input replicas and the convolved chunk, de-convolution can rely on retransmitting a replica chunk that so that it can be employed in de-convoluting the convolved chunk. As an example the Seattle chunk and Dallas chunk can be replicated in the Boston zone, e.g., as A1 and B1. The replicas, A1 and B1 can then be convolved into C. Replicas A1 and B1 can then be deleted because their information is redundantly embodied in C, albeit convolved, e.g., via an XOR process, etc. This leaves only chunk C at Boston as the backup to Seattle and Dallas. If either Seattle or Dallas is to be recovered, the corollary input data chunk can be used to de-convolve C. As an example, where the Seattle chunk, A, is corrupted, the data can be recovered from C by de-convolving C with a replica of the Dallas chunk B. As such, B can be replicated by copying B from Dallas to Boston as B1, then de-convolving C with B1 to recover A1, which can then be copied back to Seattle to replace corrupted chunk A.

In an aspect, geographically redundancy of data, chunk replicates, compressed chunk replicates, etc., can result in high counts of disk read/write events, network traffic within the zone, processor usage, etc., e.g., where a storage device comprises networked disks, etc., corresponding heat and energy usage, etc. As such, it can be desirable to reduce the use of redundant copies in creation of convolved chunks. Further, in an aspect, where all zones are equally available, where availability corresponds to characteristics of accessing data at a given zone, placing data generally evenly distributed among the ZSCs of the geographically diverse data storage system can be effective to protect data in an efficient manner. However, where some zones can have different data availabilities, e.g., it can take longer to access chunks at a ZSC that is located far away or traverses a more complex network path for data access, in a ZSC that is heavily burdened and commits fewer processing/memory resources to a data access, in a ZSC that employs slower hardware that can impact data access times at that ZSC, etc., even distribution of replicated chunks can result in longer/slower data access where a primary chunk becomes less accessible. As an example, if a first primary chunk of a first ZSC, e.g., a local chunk, etc., is replicated in a second ZSC that has a very limited network bandwidth, and a second primary chunk of the first ZSC is replicated at a third ZSC that has a very high bandwidth network connection, access to all the replicated data can be limited by the performance of the second ZSC network connection. In this example, if the first and second replicated chunks are needed to de-convolve data, then the deconvolution can be delayed until both the replicate chunks are fully accessible, e.g., copied to facilitate the deconvolution, etc., and where access at the example second ZSC can be much slower than for the third ZSC, this can significantly reduce the speed at which data can be recovered. It can therefore be desirable to store data in a geographically diverse manner predicated, at least in part, on a predicted accessibility of the replicates.

A predicted accessibility of a replicate chunk can be determined based on historical accessibility metrics, scheduling of service/maintenance, etc. Continuing the above example, where the second ZSC historically demonstrates the example limited network bandwidth, this can be measured and correlated to an availability metric, which can then be employed to predict a future or predicted accessibility, which in turn can be employed to adapt the distribution of chunk storage. In an aspect, availability can be viewed as a measurement of a ZSC to provide data access, e.g., a measurement of the capability of a ZSC, device, etc., to provide data access. In this example, less data can be stored at the second ZSC and more data can be stored at the third ZSC, such that, where the first ZSC becomes less available, the time to gather less data from the second ZSC can be more similar to the time to gather the more data from the third ZSC that if each of the second and third ZSCs stored the same or similar amount of replicate chunks. In an example, if access as a second ZSC is predicted to be one chunk per minute and at a third ZSC is predicted to be three chunks per minute, then the loss of six chunks at a first ZSC, e.g., can be recover via the replicates at the second and third ZSCs, in three minutes where each of the second and third ZSCs each store half of the six chunks, but can be two minutes where the second ZSC stored two replicate chunks and the third ZSC stored four replicate chunks, e.g., access in asymmetrical storage of replicate chunks can be ⅓ faster than symmetric storage.

To the accomplishment of the foregoing and related ends, the disclosed subject matter, then, comprises one or more of the features hereinafter more fully described. The following description and the annexed drawings set forth in detail certain illustrative aspects of the subject matter. However, these aspects are indicative of but a few of the various ways in which the principles of the subject matter can be employed. Other aspects, advantages, and novel features of the disclosed subject matter will become apparent from the following detailed description when considered in conjunction with the provided drawings.

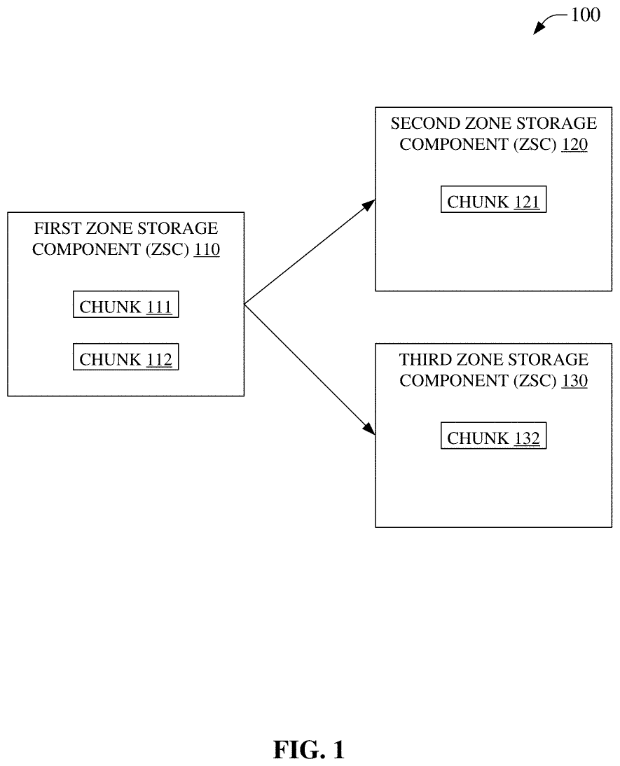

FIG. 1 is an illustration of a system 100, which can facilitate geographically diverse storage, in accordance with aspects of the subject disclosure. System 100 can comprise three or more zone storage components (ZSCs), e.g., first ZSC 110, second ZSC 120, third ZSC 130, etc. The ZSCs can communicate with the other ZSCs of system 100. A zone can correspond to a geographic location or region. As such, different zones can be associated with different geographic locations or regions. A ZSC can comprise one or more data stores in one or more locations. In an aspect, a ZSC can store at least part of a data chunk on at least part of one data storage device, e.g., hard drive, flash memory, optical disk, cloud storage, etc. Moreover, a ZSC can store at least part of one or more data chunks on one or more data storage devices, e.g., on one or more hard disks, across one or more hard disks, etc. As an example, a ZSC can comprise one or more data storage devices in one or more data storage centers corresponding to a zone, such as a first hard drive in a first location proximate to Miami, a second hard drive also proximate to Miami, a third hard drive proximate to Orlando, etc., where the related portions of the first, second, and third hard drives correspond to, for example, a ‘Miami zone’.

In an aspect, data chunks can be replicated in their source zone, in a geographically diverse zone, in their source zone and one or more geographically diverse zones, etc. As an example, a Seattle zone can comprise a first chunk that can be replicated in the Seattle zone to provide data redundancy in the Seattle zone, e.g., the first chunk can have one or more replicated chunks in the Seattle zone, such as on different storage devices corresponding to the Seattle zone, thereby providing data redundancy that can protect the data of the first chunk, for example, where a storage device storing the first chunk or a replicate thereof becomes compromised, the other replicates (or the first chunk itself) can remain uncompromised. In an aspect, data replication in a zone can be on one or more storage devices. Replication of chunks can comprise communicating data, e.g., over a network, bus, etc., to other data storage locations on the first, second, and third storage devices and, moreover, can consume data storage resources, e.g., drive space, etc., upon replication. As such, the number of replicates can be based on balancing resource costs, e.g., network traffic, processing time, cost of storage space, etc., against a level of data redundancy, e.g., how much redundancy is needed to provide a level of confidence that the data/replicated data will be available within a zone.

A geographically diverse storage system, e.g., a system comprising system 100, can create a replicate of a first chunk at a geographically diverse ZSC. As an example, chunk 111 from first ZSC 110 can be replicated as chunk 121 at second ZSC 120. As another example, chunk 112 from first ZSC 110 can be replicated as chunk 132 at third ZSC 130. The replicate at the geographically diverse ZSC can provide data redundancy. As an example, where first ZSC 110 is affiliated with a Seattle zone, and third ZSC 130 is affiliated with a Boston zone, then a regional event that compromises chunk 112 in the Seattle zone can be less likely to also compromise chunk 132 in the Boston zone.

In an aspect, replication of chunks between different zones of system 100 can consume data storage resources, e.g., network traffic, data storage space, processor time, energy, manpower, etc. As an example, replication of chunk 111 and chunk 112 at second and third ZSCs 120 and 130, e.g., as chunk 121 and chunk 132 respectively, can consume processing cycles at each of the first to third ZSCs 110, 120, and 130, can consume network resources to communicate the data between the first to third ZSCs 110, 120, and 130, can consume data storage space/resources at each of the first to third ZSCs 110, 120, and 130, etc. Moreover, where, as illustrated, a ZSC, e.g., ZSCs 120, 130, etc., stores replicates of chunks from other zones, e.g., ZSC 110, etc., the replicated chunks, e.g., chunk 121 and chunk 132, can occupy a first amount of storage space, e.g., chunks 121 and 132 consume a first amount of storage space on storage device(s) of second and third ZSC 120 and 130, respectively.

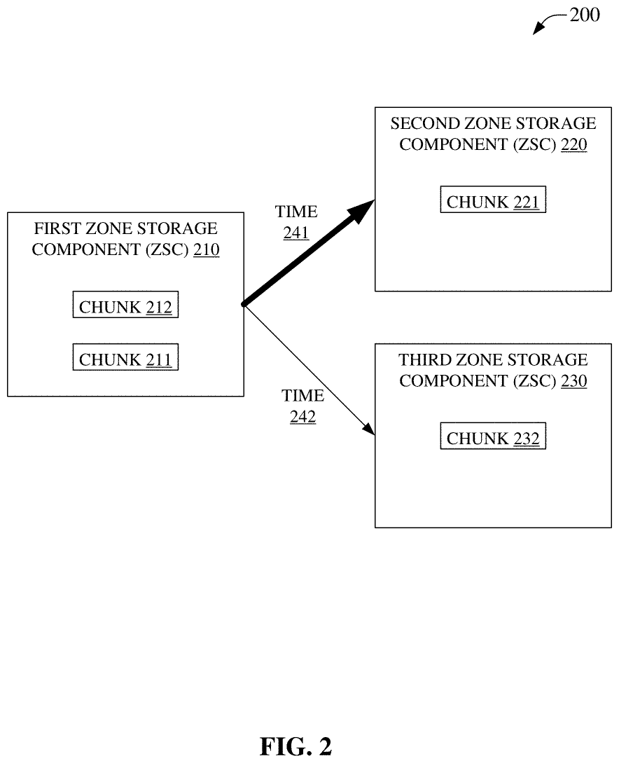

FIG. 2 is an illustration of a system 200, demonstrating asymmetrically availability, which can facilitate geographically diverse storage in accordance with aspects of the subject disclosure. System 200 can be an embodiment of example system 100, where system 100 illustrates a rudimentary geographically diverse storage system having theoretically symmetric data availability and system 200 illustrates a similar system having asymmetric data availability. In a real-world geographically diverse data storage system, it can be less likely that data availability will be symmetric or close to symmetric. In an ideal geographically diverse data storage system, the availability of data at another zone can be treated as symmetric, e.g., the time to access data between a first ZSC and a second ZSC can be treated as being the same, or similar, to a time to access data between the first ZSC and a third ZSC. This can assume the computing resources are similar in deployment and use, e.g., a same level of bandwidth, same processors under a same load, same component speeds, same amount of disruption to a network path, etc. In practice, this is unlikely to be realistic and a path and computing resources of a first pair of ZSCs is unlikely to be very similar to another path and other computing resources of a second pair of ZSCs. As an example, where first ZSC 210 is located in Boston, second ZSC 220 is located in Miami, and third ZSC 230 is located in Tokyo, it can be expected that, simply due to the transit distance and hops in the network associated with the respective network paths, an amount of time to transit the network between Boston and Miami will be less than the time to transit the network between Boston and Tokyo, e.g., time 241 can be less than time 242. Accordingly, time to access chunk 221 where chunk 211 becomes less accessible can be less than the time to access chunk 232 where chunk 212 becomes less accessible, e.g., the data accessibility can be asymmetric.

Accordingly, storing a same number of replicate chunks to each of second ZSC 220 and third ZSC 230 can result in recovery from first ZSC 210 consuming a first time generally governed by the lowest availability. As an example, where time 242 corresponds to twenty second per chunk, then even if time 241 corresponds to one second per chunk, recovery of replicates of chunks 211 and 212 from first ZSC 210, e.g., chunks 221 and 232, can take 20 seconds to complete. It can therefore be desirable to store more chunks at a ‘faster’ ZSC, e.g., a ZSC demonstrating higher data availability. In the last example, chunk 221 can be recovered in one second and no further related actions can occur at second ZSC 220 for the remaining 19 seconds that are consumed to complete access to chunk 232 at third ZSC 230. This can be viewed as wasted time. This waste can be remedied by asymmetric storage of chunks in a geographically diverse data storage system. As an example, where second ZSC 220 stores twenty replicate chunks for every one replicate chunk stored at third ZSC 230, e.g., twenty-one chunks from first ZSC 210 are replicated in system 200, then the example asymmetric availability can allow all twenty replicated chunks from second ZSC 220 to be recovered in the same twenty seconds needed to recover the one replicated chunk from third ZSC 230. This can reduce wasted time caused by asymmetry in the availability of data between ZSCs of a geographically diverse data storage system.

In an aspect, asymmetry in the availability of data between ZSCs of a geographically diverse data storage system can be related to many factors, which can include, network characteristics, ZSC hardware, ZSC software, utilization of components of a geographically diverse data storage system, e.g., system 200, etc. Network characteristics can include bandwidth, distance, number of hops, jitter, packet loss, wired/wireless links, etc. As an example, a network path to a neighboring city can, in many instances, be expected to be faster than a network path to a distant country. Moreover, a network path that is highly convoluted can be slower than a streamlined network path. Similarly, a network path through older equipment, less reliable equipment, damaged equipment, highly burdened equipment, etc., can be slower than through a lightly used, well maintained, state-of-the-art network path. In some instances, network providers may even throttle certain network paths, certain network users/customers, etc. Numerous other examples will be readily appreciated by one of skill in the art and are to be considered in the scope of the instant disclosure even where not explicitly recited for the sake of clarity and brevity. As such, network characteristics can be appreciated as impacting data availability in different parts of a geographically diverse data storage system.

Similarly, some ZSCs can be more heavily burdened than others. Accordingly, if fewer computing resources can be applied to providing data access, this can correspond to a lower data availability. As an example, a busy data center in a metropolis can take longer to access a replicated chunk than a quiet data center in a rural town. Additionally, the performance characteristics of ZSC hardware/software can similarly impact data availability, e.g., if second ZSC 220 has faster processors and updated software, it can access data faster than third ZSC 230 that can have older processors and out of date software. Numerous other examples will be readily appreciated by one of skill in the art and are to be considered in the scope of the instant disclosure even where not explicitly recited for the sake of clarity and brevity.

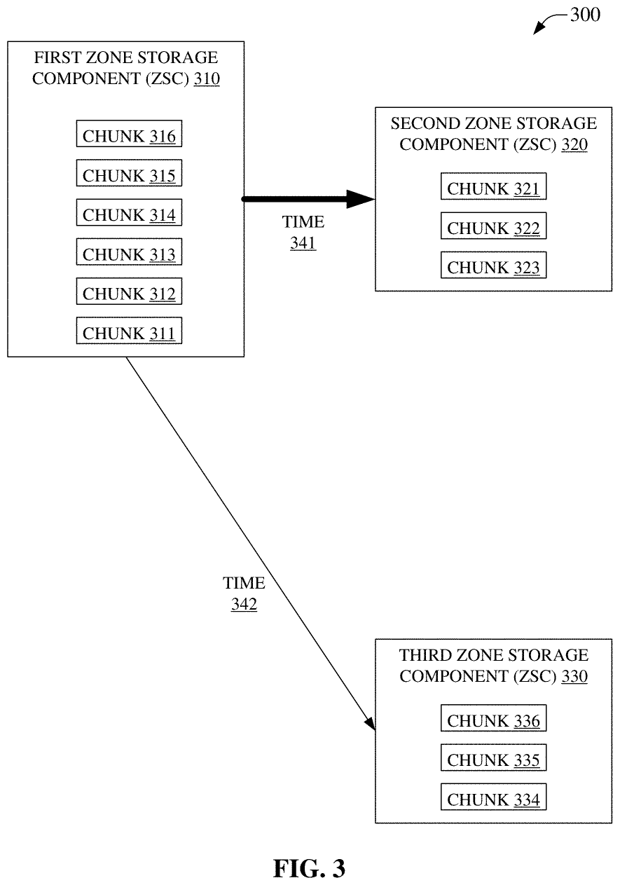

FIG. 3 is an illustration of a system 300, which can facilitate symmetric storage of data in an asymmetrically balanced geographically diverse storage, in accordance with aspects of the subject disclosure. As is noted hereinabove, a real-world geographically diverse data storage system can typically be associated with asymmetric data availability. Accordingly, time to access replicated chunks can be correspondingly distinct. System 300 can comprise ZSC 310-330, wherein first ZSC 310 stored chunks 311-316 and symmetrically replicates these chunks to other ZSCs of system 300. Accordingly, second ZSC 320 can comprise replicate chunks 321-323 and third ZSC 330 can comprise replicate chunks 334-336. System 300 can have data access asymmetries such that a time to access a replicated chunk can be different between different pairs of ZSCs, e.g., time 341 can be different from time 342.

In system 300, where time 341 can be less than time 342, symmetric storing of replicated data among the ZSCs of system 300 can result in slower access to the replicate data chunks than can be associated with asymmetric storage of replicate data, e.g., see system 400. As an example, if data availability at second ZSC 320 is half that of ZSC 330, then the total time to recover three chunks from each of the ZSCs can be governed by the data accessibility of ZSC 330. In this example, time 341 can be half of time 342. As an example, if data accessibility of second ZSC 320 is one minute per chunk, then accessing the three replicate chunks can take three minutes, e.g., time 341 can be three minutes, while data accessibility of third ZSC 330 is two minutes per chunk, e.g., doubly the accessibility of second ZSC 320, then accessing the three replicate chunks can take six minutes, e.g., time 342 can be six minutes, meaning that access to all of the replicates can take six minutes even though second ZSC 320 can have completed access in just three minutes and then can sit idle while third ZSC 330 completes access.

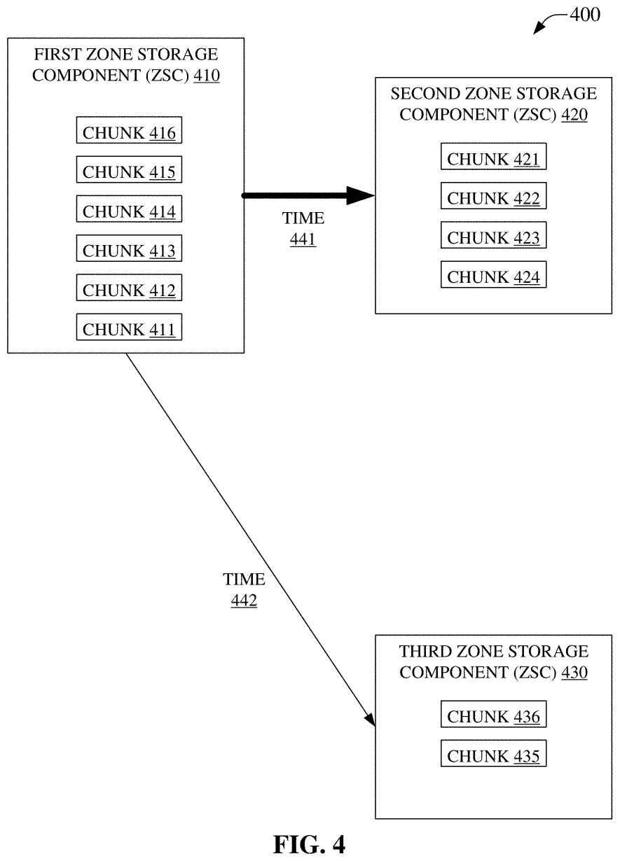

FIG. 4 is an illustration of a system 400, which can enable availability balanced storage of data in an asymmetrically balanced geographically diverse storage, in accordance with aspects of the subject disclosure. In contrast to system 300, system 400 can accommodate availability balanced storage, e.g., data can be stored based on a predicted data availability metric. In an aspect, the predicted data availability can be based on historic availability. In some embodiments, the predicted availability can also be based on anticipated events, e.g., future scheduled maintenance, etc. As an example, a historically high availability ZSC can be scheduled to be maintained which can be associated with a reduction in data availability. As another example, a historically high availability ZSC can be determined to be in a storm path that can impact associated network links, which event can be associated with a reduction in data availability. Numerous other examples will be readily appreciated by one of skill in the art and are to be considered in the scope of the instant disclosure even where not explicitly recited for the sake of clarity and brevity.

Again, as is noted hereinabove, a real-world geographically diverse data storage system can typically be associated with asymmetric data availability. Accordingly, time to access replicated chunks can be correspondingly distinct. System 400 can comprise ZSC 410-430, wherein first ZSC 410 stores chunks 411-416 and asymmetrically replicates these chunks to other ZSCs of system 400. Accordingly, second ZSC 420 can comprise replicate chunks 421-424 and third ZSC 430 can comprise replicate chunks 435-436. System 400 can have data access asymmetries such that a time to access a replicated chunk can be different between different pairs of ZSCs.

In system 400, where time 441 can be less than time 442, asymmetric storing of replicated data among the ZSCs of system 400 can result in improved access to the replicate data chunks in contrast to symmetric storage of replicate data, e.g., see system 300 showing symmetric storage in an asymmetric availability embodiment of a distributed data storage system. As an example, if data availability at second ZSC 420 is half that of ZSC 430, then the total time to recover the six chunks from both of the ZSCs can be improved over symmetric storage. In this example, time 441 can be the same as, or similar to, time 442. As an example, if data accessibility of second ZSC 420 is one minute per chunk, then accessing the four replicate chunks can take four minutes, e.g., time 441 can be four minutes, while data accessibility of third ZSC 430 is two minutes per chunk, e.g., double the accessibility of second ZSC 420, and accessing the two replicate chunks can take four minutes, e.g., time 442 can be four minutes, meaning that access to all of the replicates can take four minutes in contrast to the six minutes in the corresponding symmetric example for system 300.

System 400 can illustrate a proportionate storing of data in the geographically diverse data storage system, e.g., where second ZSC 420 has twice the availability, it can store twice the number of chunks. It is to be appreciated that other availability balanced storage schemes can also be employed. As an example, where storage space is limited on second ZSC 420, it may not be able to accommodate storing twice the number of chunks as third ZSC 430, whereby a different availability balance can be instituted. As a further example, second ZSC 420 can be associated with a much higher cost per chunk stored thereon, whereby a different availability balance can be instituted that balances cost of storage with availability of data access. Numerous other examples will be readily appreciated by one of skill in the art and are to be considered in the scope of the instant disclosure even where not explicitly recited for the sake of clarity and brevity.

In an aspect, the data availability can be predicted on historical data access capability measurements and characteristics. In an aspect, this can be an average value, a mean value, a boxcar/windowed average, etc. As an example, if data access between ZSC 310 and 330 has averaged two minutes per chunk, then this can be selected as the predicted availability and can be employed in determining an availability balance for data storage in the geographically diverse data storage system. In another example, data access between ZSC 310 and 330 has averaged two minutes per chunk for the last two weeks but may have averages one minute per chunk for the six months before then, e.g., the average in the last two weeks has become slower. In this example, the two minute per chunk average can be used, e.g., a two week windowed average, rather than about a 1.07 minute per chunk average of the last 28 weeks, etc. In this example, a weighted average could also be employed to add more or less weighting to recent metrics, etc. These examples provide illustrations of being able to tune availability balanced storage in the geographically diverse data storage system. Again, numerous other examples will be readily appreciated by one of skill in the art and are to be considered in the scope of the instant disclosure even where not explicitly recited for the sake of clarity and brevity. Generally, the greater the time to access data, the lower the availability of the data and, accordingly, it can be desirable to store fewer chunks on less available ZSCs.

In an aspect, geographically diverse data storage systems can store replicates of chunks to harden against some data becoming less available. However, these geographically diverse data storage systems can also store journal chunks that provide information about where redundant/replicated data is stored across the geographically diverse data storage system. In an embodiment, journal chunks are replicated at all ZSCs of a geographically diverse data storage system, e.g., each ZSC comprises sufficient information to access redundant/replicated data at other ZSCs. In an aspect, without journal chunks, recovering from the loss of a ZSC can fail where there is no knowledge of where the replicated chunks are stored in the geographically diverse data storage system. Accordingly, it can be important to store journal chunks with less regard to availability measurements to ensure that the journal chunks are being replicated across all zones of a geographically diverse data storage system.

Complete replication traffic, which can include replicate data chunks and journal chunks, can still be balanced in an adaptive manner to improve recovery time, etc. In an embodiment, journal chunks can simply be excluded from availability balanced storage determinations, e.g., journal chunks are replicated regardless of ZSC availability metrics and only replicate chunks are balanced. However, journal chunk replication can back up where a ZSC has a sufficiently low availability, e.g., journal chunk replication can lag where a ZSC is sufficiently unavailable. Where the lag transitions a threshold value, complete replication traffic can be availability balanced, e.g., a number of data chunks written to a ZSC with low availability can be reduced to free more computing resources to write lagging journal chunks into that low availability ZSC. This will correspond to further increasing data chunk replication to other higher availability ZSCs. In an extreme condition, only journal chunks may be written into a very low availability ZSC. However, the availability balanced storage can be adaptive, e.g., where the lag of journal chunks transitions a second threshold, the availability balanced complete replication traffic can be rebalanced, which can result in increasing a number of replicate chunks being written to the low availability ZSC, which will correspond to writing less journal chunks thereto. As an example, a ZSC can experience a temporary drop in availability that results in an backlog of journal chunks being written into that ZSC, whereby the number of data replicate chunks written to the ZSC can be reduced to allow the backlog of journal chunks to be drawn down by writing them to the ZSC faster than before. Where the backlog of journal chunks drops to a threshold level, the number of data replicate chunks can again be increased. Similarly, where the ZSC availability recovers and increases, the journal chunk backlog can be drawn down, e.g., more journal chunks can be written with the now increased availability, or the increased availability can be used to cause more data replicate chunks to be added to the now more available ZSC while maintaining the journal chunk rate. Additionally, where the ZSC remains less available, but a designated balance of journal chunks and data replicate chunks is achieved, the number of data replicate chunks can again be increased. Adapting availability balanced geographically diverse storage can therefore maintain the integrity of storage system embodiments employing journal chunks and data chunks. In an aspect, availability balanced storage can be viewed as being dynamically adaptable, e.g., it can be based on a predicted availability and can be adapted based on performance feedback. This can allow a predicted availability to be determined and employed in allocating chunks for storage across the ZSCs of a system and where this results in unsatisfactory performance, the allocation can be further adapted to cause the system to improve performance.

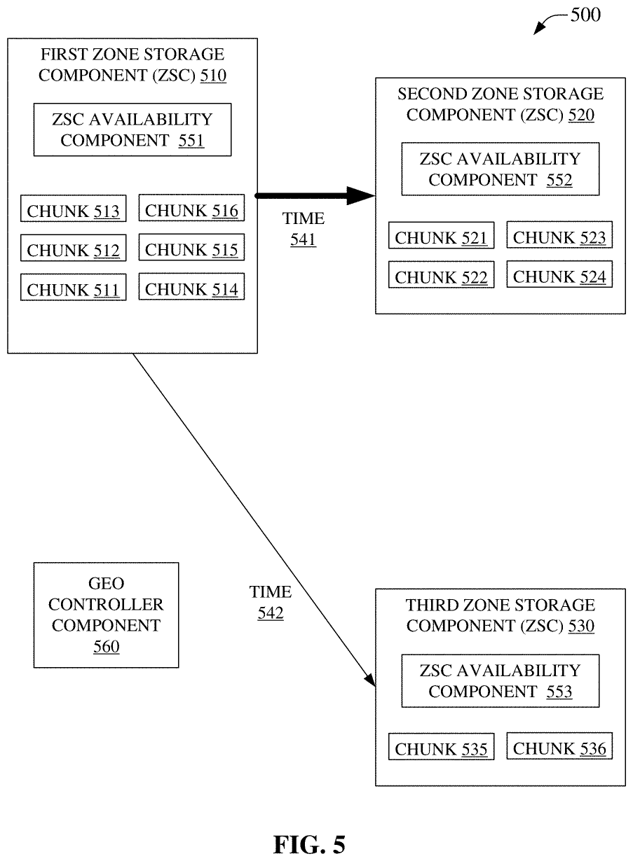

FIG. 5 is an illustration of an example system 500 that can employ a controller to facilitate availability balanced storage of data in an asymmetrically balanced geographically diverse storage, in accordance with aspects of the subject disclosure. One or more ZSCs of system 500, e.g., ZSCs 510, 520, 530, etc., can each comprise a ZSC availability component, e.g., ZSC availability component 551, 552, 553, etc. A ZSC availability component can determine an availability value, e.g., a predicted availability metric, etc., based on historic performance, current performance, known events that can affect future performance, etc. As an example, ZSC availability component 551 can analyze the historic performance of first ZSC 510 to determine that during a relevant historical period data access per chunk has taken about sixty seconds, can determine that the current state of the computing resources of first ZSC 510 is normal, e.g., experiencing an average computing resource burden, etc., and that there are no know scheduled events that would be expected to impact data availability at first ZSC 510, e.g., no schedule maintenance, not expected network slowdowns/outages, etc., to which ZSC availability component 551 can determine that a predicted availability will be about sixty seconds per chunk. In another example, ZSC availability component 552 can analyze the historic performance of second ZSC 520 to determine that during a relevant historical period data access per chunk has taken about two minutes, can determine that the current state of the computing resources of second ZSC 520 is heavily burdened, e.g., a processor, network, memory, storage, etc., resource is being used more heavily than normal, which, for example can be used to predict adding sixty seconds per chunk for a data access event, and that there are no know scheduled events that would be expected to impact data availability at second ZSC 520, to which ZSC availability component 552 can determine that a predicted availability will be about three minutes per chunk. Numerous other examples will be readily appreciated by one of skill in the art and are to be considered in the scope of the instant disclosure even where not explicitly recited for the sake of clarity and brevity. ZSC availability components can communicate information to other ZSCs of system 500 to enable balancing of storage based on predicted availability, e.g., availability balanced storage.

In some embodiments, system 500 can comprise GEO controller component 560. GEO controller component 560 can facilitate availability balanced storage, for example by collecting/receiving data from one or more ZSC availability components. GEO controller component 560 can further facilitate availability balanced storage, for example, by determining ZSC availability data based on measurements via one or more other components that can measure computing metrics at, or between, components of system 500, e.g., between ZSCs, etc., to determine availability metric type data. GEO controller component 560 can employ these types of received data to determine predicted inter-ZSC availability, which can then be employed by GEO controller component 560 to coordinate, orchestrate, etc., availability balanced storage, e.g., GEO controller component 560 can indicate where chunks are to be stored in system 500 to enable asymmetric chunk storage that is considerate of the predicted availability of ZSCs, or between ZSCs, of system 500. In some embodiments, GEO controller component 560 can be comprised in a ZSC of system 500, can be distributed among two or more ZSCs of system 500, can be comprised in a component of system 500 that is not a ZSC, can be located remotely from system 500, e.g., can be component of a third-party provider, etc.

Accordingly, system 500 can comprise ZSC 510-530, wherein first ZSC 510 can store chunks 511-516 and can asymmetrically replicate these chunks to other ZSCs of system 500, e.g., based on predicted availability values from one or more of ZSC availability components 551-553 and/or GEO controller component 560. As such, second ZSC 520 can comprise replicate chunks 521-524 and third ZSC 530 can comprise replicate chunks 535-536 based on predicted availability values indicating, for example, that time 541 is about half of time 542, e.g., the availability of second ZSC 520 to first ZSC 510 is about twice that of the availability of third ZSC 530 to first ZSC 510.

In system 500, where time 541 can be, for example, half of time 542, asymmetric storing of replicated data among the ZSCs of system 500 can result in improved access to the replicate data chunks in contrast to symmetric storage of replicate data, e.g., see system 300. As an example, if data availability for second ZSC 520 is three minutes per chunk, then the total time to recover the four chunks from second ZSC 520 can be about twelve minutes. In this example, data accessibility of third ZSC 530 can be six minutes, e.g., twice that of second ZSC 520, and time to recover the two chunks can also be about twelve minutes. As such, use of asymmetric availability information can provide an avenue to balance data storage such that access times can also be balanced rather than using symmetric data storage that can result in total data access times being governed by a ZSC having different availability than other ZSCs of a geographically diverse data storage system, e.g., if the above example values are plugged into a symmetric example, such as system 300, then total access time can be eighteen minutes to access three chunks storage at third ZSC 330.

System 500 can, again, illustrate a proportionate storing of data in the geographically diverse data storage system, e.g., where second ZSC 520 has twice the availability of third ZSC 530, it can store twice the number of chunks. It is again to be appreciated that other availability balanced storage schemes can also be employed, all of which are to be considered in the scope of the instant disclosure even where not explicitly recited for the sake of clarity and brevity.

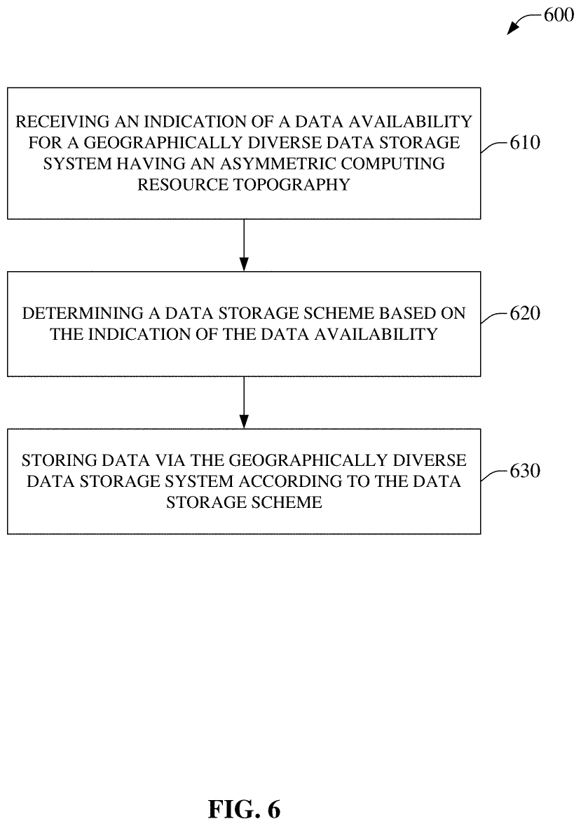

In view of the example system(s) described above, example method(s) that can be implemented in accordance with the disclosed subject matter can be better appreciated with reference to flowcharts in FIG. 6-FIG. 8. For purposes of simplicity of explanation, example methods disclosed herein are presented and described as a series of acts; however, it is to be understood and appreciated that the claimed subject matter is not limited by the order of acts, as some acts may occur in different orders and/or concurrently with other acts from that shown and described herein. For example, one or more example methods disclosed herein could alternatively be represented as a series of interrelated states or events, such as in a state diagram. Moreover, interaction diagram(s) may represent methods in accordance with the disclosed subject matter when disparate entities enact disparate portions of the methods. Furthermore, not all illustrated acts may be required to implement a described example method in accordance with the subject specification. Further yet, two or more of the disclosed example methods can be implemented in combination with each other, to accomplish one or more aspects herein described. It should be further appreciated that the example methods disclosed throughout the subject specification are capable of being stored on an article of manufacture (e.g., a computer-readable medium) to allow transporting and transferring such methods to computers for execution, and thus implementation, by a processor or for storage in a memory.

FIG. 6 is an illustration of an example method 600, facilitating employing availability balanced storage of data in an asymmetrically balanced geographically diverse storage, in accordance with aspects of the subject disclosure. Method 600, at 610, can comprise receiving an indication of a data availability for a geographically diverse data storage system, e.g., a predicted data availability of data stored on at a ZSC, etc. A real-world geographically diverse data storage system can typically be associated with asymmetric data availability. In an aspect, the geographically diverse data storage system can have an asymmetric computing resource topography, e.g., the availability of stored data, and typically also the speed of initially storing said data, can be asymmetric due to asymmetries in the computing resources of a geographically diverse data storage system, such as, differences between network paths connecting different ZSCs of a the geographically diverse data storage system, differences in processor performance and/or processor burden for different components of the geographically diverse data storage system, differences in uptime for different geographically diverse data storage system hardware and/or software, planned maintenance for some but not necessarily all zones/devices/components of a geographically diverse data storage system, etc.

Accordingly, receiving an indication as to the possible asymmetries of data access in the geographically diverse data storage system, e.g., data availability, can be valuable in improving the performance of the geographically diverse data storage system. In an aspect, the predicted data availability can be based on historic availability. In some embodiments, the predicted availability can also be based on anticipated events, e.g., future scheduled maintenance, etc. As an example, a historically high availability ZSC can be scheduled to be maintained which can be associated with a reduction in data availability. As another example, a historically high availability ZSC can be determined to be in a storm path that can impact associated network links, which event can be associated with a reduction in data availability. Numerous other examples will be readily appreciated by one of skill in the art and are to be considered in the scope of the instant disclosure even where not explicitly recited for the sake of clarity and brevity. Generally, time to access replicated chunks in the geographically diverse data storage system can correspond to asymmetries in the geographically diverse data storage system computing resources. As an example, a first ZSC can store chunks and can asymmetrically replicates those chunks to other ZSCs. Accordingly, a second ZSC can comprise some replicate chunks and third ZSC can comprise other replicated chunks, each stored according to an availability balanced scheme. An indication of data availability can be employed to determine which ZSCs store which replicated chunks in the given example. In this example, assuming the second ZSC has twice the data availability of the third ZSC, the replicate chunks can be stored, for example, in a two-to-one ration by the second ZSC as compared to the third ZSC, e.g., for six replicate chunks, four can be stored at the second ZSC and two at the third ZSC. This can allow for an expectation of recovering fewer chunks from a ‘slower’ ZSC, e.g., the third ZSC, in a time similar to what can be expected to recover more chunks from a ‘faster’ ZSC, e.g., the second ZSC. In this example, letting second ZSC correspond to recovery at one chunk per minute and letting third ZSC be one chunk per two minutes, e.g., second ZSC is twice as fast, or has double the data availability, as third ZSC, then recovery can be four minutes for all six chunks. This can be contrasted with symmetric chunk storage and recovery, e.g., three chunks for each ZSC, which would be expected to complete in six minutes, indicating that the third ZSC limits the speed of recovery.

At 620, method 600 can comprise determining a data storage scheme based on the indication of the data availability. Where asymmetries in the geographically diverse data storage system computing resources can result in asymmetries in the data availability, a data storage scheme can be determined, selected, generated, etc., that can balance data storage in a manner that reflects the asymmetry of the geographically diverse data storage system. In an aspect, a predicted data availability can be based on historical data access capability measurements and characteristics. In an aspect, this can be an average value, a mean value, a boxcar/windowed average, etc. Additionally, other characteristics of the geographically diverse data storage system can be employed, e.g., scheduled maintenance, weather impacts on network elements, etc. As such, the indication of the data availability can anticipate data access based on already experience performance and other events for the geographically diverse data storage system. Generally, the greater the time to access data, the lower the availability of the data and, accordingly, it can be desirable to store fewer chunks on less available ZSCs. A determined data storage scheme can allow storage of data to reflect accessibility and therefore promote more efficient data access to data stored according to the data storage scheme.

It is noted that the above example, can illustrate a proportionate storing of data in the geographically diverse data storage system, e.g., where the second ZSC has twice the availability, it can store twice the number of chunks as the third ZSC. It is noted that other availability balanced storage schemes can also be employed. As an example, where storage space is limited on a ZSC, the ZSC may not be able to accommodate storing a proportionate number of chunks, whereby a different availability balance can be instituted. As a further example, a ZSC can be associated with a much higher cost per chunk stored thereon, whereby a different availability balance can be instituted that balances cost of storage with availability of data access. Numerous other examples will be readily appreciated by one of skill in the art and are to be considered in the scope of the instant disclosure even where not explicitly recited for the sake of clarity and brevity.

Method 600, at 630, can comprise storing data according to the data storage scheme. At this point method 600 can end. In an aspect, a geographically diverse data storage system employing method 600 can store replicates of chunks to harden against some data becoming less available. By storing data according in a manner that reflects a data availability metric at a first time, data can be accessed in an optimized manner at a second time where the data availability metric reasonably predicted the data availability at the second time. As an example, if a geographically diverse data storage system regularly encounters data access times in Europe that are double that of data access times in Asia, data storage can be balanced between Europe and Asia to reflect that condition, such that, where that condition continues to hold accurate at a future date, accessing the data can be more optimal than if the data storage had not been balanced based on the historical difference in data accessibility.

As is disclosed elsewhere herein, where the current performance differs from the predicted performance, data storage can be adapted. In some embodiments, where there is a threshold difference between actual performance and predicted performance, storage can even be rebalanced. As an example, where an asymmetry is determined, and data storage is balanced based on the corresponding data availability, for example at a two-to-one ratio, then that asymmetry is removed, for example where a data center is upgraded, changes to the network balance bandwidth, etc., the data stored at the two-to-one ration can be rebalanced at a different ratio, e.g., where the asymmetry is removed, at a one-to-one ratio, such as by moving some chunks from one ZSC to another ZSC.

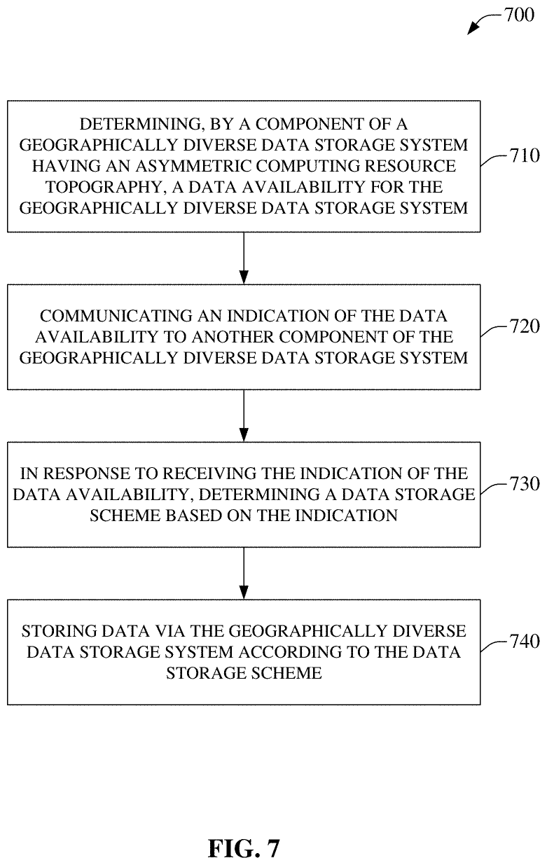

FIG. 7 is an illustration of an example method 700, which can facilitate determining availability balanced storage of data in an asymmetrically balanced geographically diverse storage system, in accordance with aspects of the subject disclosure. At 710, method 700 can comprise determining a data availability. The determination can be performed by a component of a geographically diverse data storage system. As an example, a geographically diverse data storage system having an asymmetric computing resource topography can determine that data availability is different among different ZSCs of the geographically diverse data storage system and, accordingly, can determine a data availability that can reflect this asymmetry in data access among the different ZSCs.

At 720, method 700 can comprise, communicating an indicator of the data availability to another component of the geographically diverse data storage system. In an embodiment, one or more of the ZSCs comprising a geographically diverse data storage system can determine a corresponding data availability that can be communicated to other ZSCs of the geographically diverse data storage system. As such, these other ZSCs can employ a data availability received from a first ZSC to availability balance storage of chunks to be stored at the first ZSC. In some embodiments, geographically diverse data storage system can comprise a controller component that can receive data availability indications from ZSCs of the geographically diverse data storage system such that the controller component can coordinate, orchestrate, etc., availability balanced storage across the ZSCs of the geographically diverse data storage system.

At 730, method 700 can comprise determining a data storage scheme based on the indication of the data availability. Asymmetries in the geographically diverse data storage system computing resources can result in asymmetries in the data availability, a data storage scheme can be determined, selected, generated, etc., that can balance data storage in a manner that reflects the asymmetry of the geographically diverse data storage system. In an aspect, a predicted data availability can be based on historical data access capability measurements and characteristics. In an aspect, this can be an average value, a mean value, a boxcar/windowed average, etc. Additionally, other characteristics of the geographically diverse data storage system can be employed, e.g., scheduled maintenance, weather impacts on network elements, etc. As such, the indication of the data availability can anticipate data access based on already experience performance and other events for the geographically diverse data storage system. Generally, the greater the time to access data, the lower the availability of the data and, accordingly, it can be desirable to store fewer chunks on less available ZSCs. A determined data storage scheme can allow storage of data to reflect accessibility and therefore promote more efficient data access to data stored according to the data storage scheme. The data storage scheme can be proportionate or non-proportionate as is disclosed elsewhere herein.

Method 700, at 740, can comprise storing data according to the data storage scheme. At this point method 700 can end. In an aspect, a geographically diverse data storage system employing method 700 can store replicates of chunks to harden against some data becoming less available. By storing data according in a manner that reflects a data availability metric at a first time, data can be accessed in an optimized manner at a second time where the data availability metric reasonably predicted the data availability at the second time. Also as is disclosed elsewhere herein, where the current performance differs from the predicted performance, data storage can be adapted.

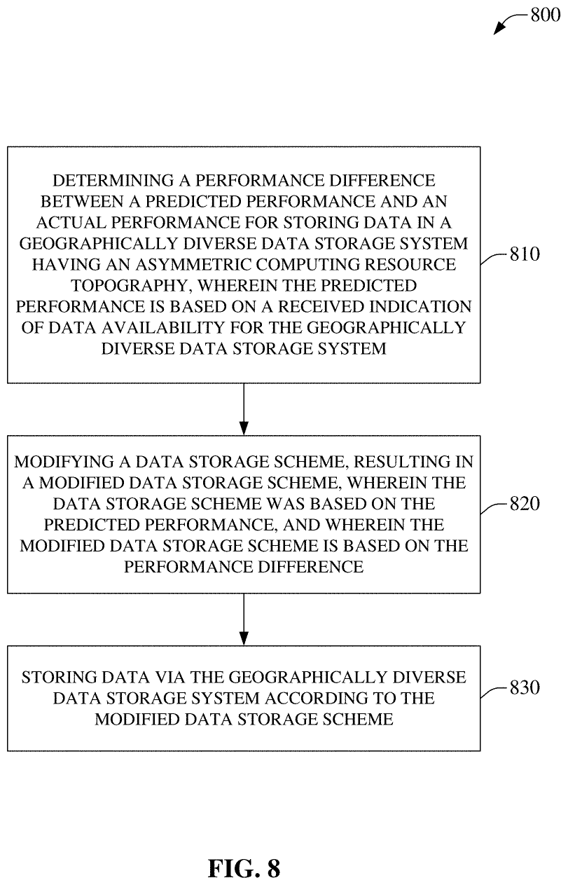

FIG. 8 is an illustration of an example method 800, which can enable adapting availability balanced storage of data in an asymmetrically balanced geographically diverse storage via a centralized controller, in accordance with aspects of the subject disclosure. At 810, method 800 can comprise determining a performance difference between a predicted performance and an actual performance for storing data in a geographically diverse data storage system. The geographically diverse data storage system can be associated with an asymmetry in computing resources, e.g., network resources, computational resources, memory resources, etc., that can affect data accessibility, e.g., not all data can be accessed equally at all parts of a geographically diverse data storage system because not all parts of the geographically diverse data storage system have the same computing resources. This observation can be employed to store data according to an availability balancing storage scheme, e.g., data can be stored based on a prediction of how accessible it is expected to be in the future. Accordingly, where the actual performance of the geographically diverse data storage system differs from a predicted performance, the difference in performance can be employed to adapt the availability balanced storage scheme. In an aspect, the predicted performance can be based on a received indication of data availability for the geographically diverse data storage system. The current performance can be measured and compared to the predicted performance to determine a performance difference. As an example, if first ZSC is heavily burdened resulting in a predicted performance, e.g., data availability, that is half of a second ZSC, then the availability balance storage scheme can, for example, store twice the chunks at the second ZSC as the first ZSC. However, in this example, where data accessibility at the first ZSC is measured to be the same as at the second ZSC, for example where an addition of a third ZSC has reduced the burdening of the first ZSC was improved, then the data storage scheme can be modified, for example to storing a same number of chunks on the first and second ZSCs. In some embodiments, previously stored chunks one the first and second ZSCs can even be rebalanced based on the updated data storage scheme.

Moreover, geographically diverse data storage systems can, in some embodiments, also store journal chunks that provide information about where data chunks are stored across the geographically diverse data storage system, etc. In an embodiment, journal chunks can be replicated at all ZSCs of a geographically diverse data storage system, e.g., each ZSC comprises sufficient information to access redundant/replicated data at other ZSCs. As such, complete replication traffic can include replicate data chunks and journal chunks and can be availability balanced to improve recovery time, etc. In an embodiment, journal chunks can simply be excluded from availability balanced storage determinations, e.g., journal chunks can be replicated regardless of ZSC availability metrics and only replicate chunks are then balanced. However, where journal chunk replication can back up for a ZSC has a sufficiently low availability, e.g., journal chunk replication can lag where a ZSC is unavailable at first threshold level. Adaptive availability balancing where the lag transitions the first threshold value, can cause complete replication traffic, e.g., both the data and journal chunks, to be availability balanced, e.g., a number of data chunks written to a ZSC with low availability can be reduced to free more computing resources to write more journal chunks from the backlog into that low availability ZSC. This can correspond to further increasing data chunk replication to other higher availability ZSCs. In an extreme condition, only journal chunks may be written into a very low availability ZSC. Moreover, where the lag of journal chunks transitions a second threshold, the availability balanced can be further adapted, which can result in again increasing a number of replicate chunks and reducing the number of journal chunks being written to the low availability ZSC. This can illustrate using a determined performance difference, e.g., the difference between the predicted availability and the actual availability of the ZSC resulting in the backlog of journal chunks, to adapt the storage scheme, e.g., reducing the storage of data chunks to allow more journal chunks to be written to the ZSC to reduce the backlog, and again when the backlog of journal chunks is reduces to increase the proportion of data chunks being written to the ZSC.

Method 800, at 820, can comprise modifying a data storage scheme, resulting in a modified data storage scheme. The data storage scheme can be based on the predicted performance. The modified data storage scheme can be based on the performance difference. Adapting availability balanced geographically diverse storage can therefore maintain the integrity of storage system embodiments employing journal chunks and data chunks. In an aspect, availability balanced storage can be viewed as being dynamically adaptable, e.g., it can be based on a predicted availability and can be adapted based on performance feedback. This can allow a predicted availability to be determined and employed in allocating chunks for storage across the ZSCs of a system and where this results in a performance difference, the allocation can be further adapted to cause the system to improve performance.

Method 800, at 830, can comprise storing data according to the modified data storage scheme. At this point method 800 can end. In an aspect, a geographically diverse data storage system employing method 800 can store replicates of chunks to harden against some data becoming less available. By storing data according in a manner that reflects a data availability metric at a first time, and correspondingly adapting the availability balanced data storage scheme at a second time based on a determined performance difference between the predicted availability and measurable availability, data can be accessed in an optimized manner at a third time where the data availability metric did not reasonably predicted the data availability at the second time and the modification to the data storage scheme does reasonable predict data availability at the third time.

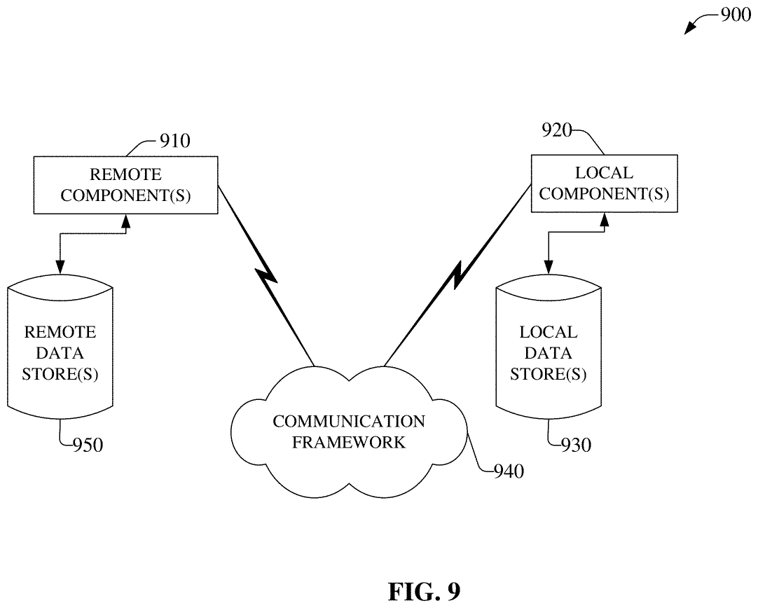

FIG. 9 is a schematic block diagram of a computing environment 900 with which the disclosed subject matter can interact. The system 900 comprises one or more remote component(s) 910. The remote component(s) 910 can be hardware and/or software (e.g., threads, processes, computing devices). In some embodiments, remote component(s) 910 can be a remotely located ZSC connected to a local ZSC via communication framework 940. Communication framework 940 can comprise wired network devices, wireless network devices, mobile devices, wearable devices, radio access network devices, gateway devices, femtocell devices, servers, etc.

The system 900 also comprises one or more local component(s) 920. The local component(s) 920 can be hardware and/or software (e.g., threads, processes, computing devices). In some embodiments, local component(s) 920 can comprise a local ZSC connected to a remote ZSC via communication framework 940, GEO controller component 560, etc. In an aspect the remotely located ZSC or local ZSC can be embodied in ZSC 110-130, 210-230, 310-330, 410-430, 510-530, etc.

One possible communication between a remote component(s) 910 and a local component(s) 920 can be in the form of a data packet adapted to be transmitted between two or more computer processes. Another possible communication between a remote component(s) 910 and a local component(s) 920 can be in the form of circuit-switched data adapted to be transmitted between two or more computer processes in radio time slots. The system 900 comprises a communication framework 940 that can be employed to facilitate communications between the remote component(s) 910 and the local component(s) 920, and can comprise an air interface, e.g., Uu interface of a UMTS network, via a long-term evolution (LTE) network, etc. Remote component(s) 910 can be operably connected to one or more remote data store(s) 950, such as a hard drive, solid state drive, SIM card, device memory, etc., that can be employed to store information on the remote component(s) 910 side of communication framework 940. Similarly, local component(s) 920 can be operably connected to one or more local data store(s) 930, that can be employed to store information on the local component(s) 920 side of communication framework 940. As examples, information corresponding to chunks stored on ZSCs can be communicated via communication framework 940 to other ZSCs of a storage network, e.g., to facilitate compression and storage in partial or complete chunks on a ZSC as disclosed herein.

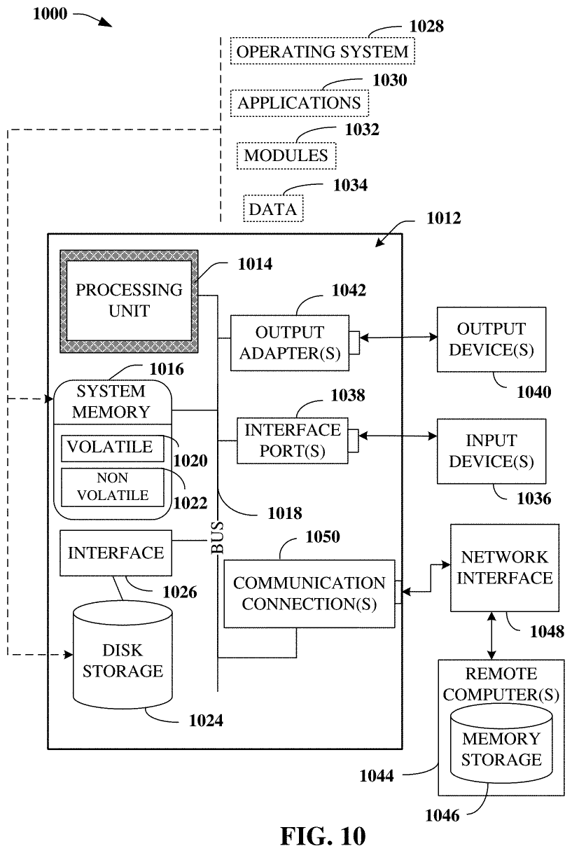

In order to provide a context for the various aspects of the disclosed subject matter, FIG. 10, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that performs particular tasks and/or implement particular abstract data types.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It is noted that the memory components described herein can be either volatile memory or nonvolatile memory, or can comprise both volatile and nonvolatile memory, by way of illustration, and not limitation, volatile memory 1020 (see below), non-volatile memory 1022 (see below), disk storage 1024 (see below), and memory storage 1046 (see below). Further, nonvolatile memory can be included in read only memory, programmable read only memory, electrically programmable read only memory, electrically erasable read only memory, or flash memory. Volatile memory can comprise random access memory, which acts as external cache memory. By way of illustration and not limitation, random access memory is available in many forms such as synchronous random access memory, dynamic random access memory, synchronous dynamic random access memory, double data rate synchronous dynamic random access memory, enhanced synchronous dynamic random access memory, SynchLink dynamic random access memory, and direct Rambus random access memory. Additionally, the disclosed memory components of systems or methods herein are intended to comprise, without being limited to comprising, these and any other suitable types of memory.

Moreover, it is noted that the disclosed subject matter can be practiced with other computer system configurations, comprising single-processor or multiprocessor computer systems, mini-computing devices, mainframe computers, as well as personal computers, hand-held computing devices (e.g., personal digital assistant, phone, watch, tablet computers, netbook computers, . . . ), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

FIG. 10 illustrates a block diagram of a computing system 1000 operable to execute the disclosed systems and methods in accordance with an embodiment. Computer 1012, which can be, for example, comprised in a ZSC, e.g., 110-130, 210-230, 310-330, 410-430, 510-530, GEO controller component 560, etc., can comprise a processing unit 1014, a system memory 1016, and a system bus 1018. System bus 1018 couples system components comprising, but not limited to, system memory 1016 to processing unit 1014. Processing unit 1014 can be any of various available processors. Dual microprocessors and other multiprocessor architectures also can be employed as processing unit 1014.

System bus 1018 can be any of several types of bus structure(s) comprising a memory bus or a memory controller, a peripheral bus or an external bus, and/or a local bus using any variety of available bus architectures comprising, but not limited to, industrial standard architecture, micro-channel architecture, extended industrial standard architecture, intelligent drive electronics, video electronics standards association local bus, peripheral component interconnect, card bus, universal serial bus, advanced graphics port, personal computer memory card international association bus, Firewire (Institute of Electrical and Electronics Engineers 1194), and small computer systems interface.

System memory 1016 can comprise volatile memory 1020 and nonvolatile memory 1022. A basic input/output system, containing routines to transfer information between elements within computer 1012, such as during start-up, can be stored in nonvolatile memory 1022. By way of illustration, and not limitation, nonvolatile memory 1022 can comprise read only memory, programmable read only memory, electrically programmable read only memory, electrically erasable read only memory, or flash memory. Volatile memory 1020 comprises read only memory, which acts as external cache memory. By way of illustration and not limitation, read only memory is available in many forms such as synchronous random access memory, dynamic read only memory, synchronous dynamic read only memory, double data rate synchronous dynamic read only memory, enhanced synchronous dynamic read only memory, SynchLink dynamic read only memory, Rambus direct read only memory, direct Rambus dynamic read only memory, and Rambus dynamic read only memory.

Computer 1012 can also comprise removable/non-removable, volatile/non-volatile computer storage media. FIG. 10 illustrates, for example, disk storage 1024. Disk storage 1024 comprises, but is not limited to, devices like a magnetic disk drive, floppy disk drive, tape drive, flash memory card, or memory stick. In addition, disk storage 1024 can comprise storage media separately or in combination with other storage media comprising, but not limited to, an optical disk drive such as a compact disk read only memory device, compact disk recordable drive, compact disk rewritable drive or a digital versatile disk read only memory. To facilitate connection of the disk storage devices 1024 to system bus 1018, a removable or non-removable interface is typically used, such as interface 1026.

Computing devices typically comprise a variety of media, which can comprise computer-readable storage media or communications media, which two terms are used herein differently from one another as follows.

Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can comprise, but are not limited to, read only memory, programmable read only memory, electrically programmable read only memory, electrically erasable read only memory, flash memory or other memory technology, compact disk read only memory, digital versatile disk or other optical disk storage, magnetic cassettes, magnetic tape, magnetic disk storage or other magnetic storage devices, or other tangible media which can be used to store desired information. In this regard, the term “tangible” herein as may be applied to storage, memory or computer-readable media, is to be understood to exclude only propagating intangible signals per se as a modifier and does not relinquish coverage of all standard storage, memory or computer-readable media that are not only propagating intangible signals per se. In an aspect, tangible media can comprise non-transitory media wherein the term “non-transitory” herein as may be applied to storage, memory or computer-readable media, is to be understood to exclude only propagating transitory signals per se as a modifier and does not relinquish coverage of all standard storage, memory or computer-readable media that are not only propagating transitory signals per se. Computer-readable storage media can be accessed by one or more local or remote computing devices, e.g., via access requests, queries or other data retrieval protocols, for a variety of operations with respect to the information stored by the medium. As such, for example, a computer-readable medium can comprise executable instructions stored thereon that, in response to execution, can cause a system comprising a processor to perform operations, comprising determining a first availability value and a second availability value, wherein the first availability value is based on a time to access a first data stored via a first zone of a geographically diverse data storage system, wherein the second availability value is based on a time to access a second data stored via a second zone of the geographically diverse data storage system, and wherein the geographically diverse data storage system has an asymmetric computing resource topography. The operations can further comprise determining a data storage scheme based on the first availability value and the second availability value and storing chunks via the geographically diverse data storage system according to the data storage scheme, as disclosed herein.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

It can be noted that FIG. 10 describes software that acts as an intermediary between users and computer resources described in suitable operating environment 1000. Such software comprises an operating system 1028. Operating system 1028, which can be stored on disk storage 1024, acts to control and allocate resources of computer system 1012. System applications 1030 take advantage of the management of resources by operating system 1028 through program modules 1032 and program data 1034 stored either in system memory 1016 or on disk storage 1024. It is to be noted that the disclosed subject matter can be implemented with various operating systems or combinations of operating systems.

A user can enter commands or information into computer 1012 through input device(s) 1036. In some embodiments, a user interface can allow entry of user preference information, etc., and can be embodied in a touch sensitive display panel, a mouse/pointer input to a graphical user interface (GUI), a command line controlled interface, etc., allowing a user to interact with computer 1012. Input devices 1036 comprise, but are not limited to, a pointing device such as a mouse, trackball, stylus, touch pad, keyboard, microphone, joystick, game pad, satellite dish, scanner, TV tuner card, digital camera, digital video camera, web camera, cell phone, smartphone, tablet computer, etc. These and other input devices connect to processing unit 1014 through system bus 1018 by way of interface port(s) 1038. Interface port(s) 1038 comprise, for example, a serial port, a parallel port, a game port, a universal serial bus, an infrared port, a Bluetooth port, an IP port, or a logical port associated with a wireless service, etc. Output device(s) 1040 use some of the same type of ports as input device(s) 1036.

Thus, for example, a universal serial busport can be used to provide input to computer 1012 and to output information from computer 1012 to an output device 1040. Output adapter 1042 is provided to illustrate that there are some output devices 1040 like monitors, speakers, and printers, among other output devices 1040, which use special adapters. Output adapters 1042 comprise, by way of illustration and not limitation, video and sound cards that provide means of connection between output device 1040 and system bus 1018. It should be noted that other devices and/or systems of devices provide both input and output capabilities such as remote computer(s) 1044.

Computer 1012 can operate in a networked environment using logical connections to one or more remote computers, such as remote computer(s) 1044. Remote computer(s) 1044 can be a personal computer, a server, a router, a network PC, cloud storage, a cloud service, code executing in a cloud-computing environment, a workstation, a microprocessor-based appliance, a peer device, or other common network node and the like, and typically comprises many or all of the elements described relative to computer 1012. A cloud computing environment, the cloud, or other similar terms can refer to computing that can share processing resources and data to one or more computer and/or other device(s) on an as needed basis to enable access to a shared pool of configurable computing resources that can be provisioned and released readily. Cloud computing and storage solutions can store and/or process data in third-party data centers which can leverage an economy of scale and can view accessing computing resources via a cloud service in a manner similar to a subscribing to an electric utility to access electrical energy, a telephone utility to access telephonic services, etc.

For purposes of brevity, only a memory storage device 1046 is illustrated with remote computer(s) 1044. Remote computer(s) 1044 is logically connected to computer 1012 through a network interface 1048 and then physically connected by way of communication connection 1050. Network interface 1048 encompasses wire and/or wireless communication networks such as local area networks and wide area networks. Local area network technologies comprise fiber distributed data interface, copper distributed data interface, Ethernet, Token Ring and the like. Wide area network technologies comprise, but are not limited to, point-to-point links, circuit-switching networks like integrated services digital networks and variations thereon, packet switching networks, and digital subscriber lines. As noted below, wireless technologies may be used in addition to or in place of the foregoing.

Communication connection(s) 1050 refer(s) to hardware/software employed to connect network interface 1048 to bus 1018. While communication connection 1050 is shown for illustrative clarity inside computer 1012, it can also be external to computer 1012. The hardware/software for connection to network interface 1048 can comprise, for example, internal and external technologies such as modems, comprising regular telephone grade modems, cable modems and digital subscriber line modems, integrated services digital network adapters, and Ethernet cards.

The above description of illustrated embodiments of the subject disclosure, comprising what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit, a digital signal processor, a field programmable gate array, a programmable logic controller, a complex programmable logic device, a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units.

As used in this application, the terms “component,” “system,” “platform,” “layer,” “selector,” “interface,” and the like are intended to refer to a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or a firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. Moreover, the use of any particular embodiment or example in the present disclosure should not be treated as exclusive of any other particular embodiment or example, unless expressly indicated as such, e.g., a first embodiment that has aspect A and a second embodiment that has aspect B does not preclude a third embodiment that has aspect A and aspect B. The use of granular examples and embodiments is intended to simplify understanding of certain features, aspects, etc., of the disclosed subject matter and is not intended to limit the disclosure to said granular instances of the disclosed subject matter or to illustrate that combinations of embodiments of the disclosed subject matter were not contemplated at the time of actual or constructive reduction to practice.

Further, the term “include” is intended to be employed as an open or inclusive term, rather than a closed or exclusive term. The term “include” can be substituted with the term “comprising” and is to be treated with similar scope, unless otherwise explicitly used otherwise. As an example, “a basket of fruit including an apple” is to be treated with the same breadth of scope as, “a basket of fruit comprising an apple.”

Furthermore, the terms “user,” “subscriber,” “customer,” “consumer,” “prosumer,” “agent,” and the like are employed interchangeably throughout the subject specification, unless context warrants particular distinction(s) among the terms. It should be appreciated that such terms can refer to human entities, machine learning components, or automated components (e.g., supported through artificial intelligence, as through a capacity to make inferences based on complex mathematical formalisms), that can provide simulated vision, sound recognition and so forth.

Aspects, features, or advantages of the subject matter can be exploited in substantially any, or any, wired, broadcast, wireless telecommunication, radio technology or network, or combinations thereof. Non-limiting examples of such technologies or networks comprise broadcast technologies (e.g., sub-Hertz, extremely low frequency, very low frequency, low frequency, medium frequency, high frequency, very high frequency, ultra-high frequency, super-high frequency, extremely high frequency, terahertz broadcasts, etc.); Ethernet; X.25; powerline-type networking, e.g., Powerline audio video Ethernet, etc.; femtocell technology; Wi-Fi; worldwide interoperability for microwave access; enhanced general packet radio service; second generation partnership project (2G or 2GPP); third generation partnership project (3G or 3GPP); fourth generation partnership project (4G or 4GPP); long term evolution (LTE); fifth generation partnership project (5G or 5GPP); third generation partnership project universal mobile telecommunications system; third generation partnership project 2; ultra mobile broadband; high speed packet access; high speed downlink packet access; high speed uplink packet access; enhanced data rates for global system for mobile communication evolution radio access network; universal mobile telecommunications system terrestrial radio access network; or long term evolution advanced. As an example, a millimeter wave broadcast technology can employ electromagnetic waves in the frequency spectrum from about 30 GHz to about 300 GHz. These millimeter waves can be generally situated between microwaves (from about 1 GHz to about 30 GHz) and infrared (IR) waves, and are sometimes referred to extremely high frequency (EHF). The wavelength (λ) for millimeter waves is typically in the 1-mm to 10-mm range.

The term “infer” or “inference” can generally refer to the process of reasoning about, or inferring states of, the system, environment, user, and/or intent from a set of observations as captured via events and/or data. Captured data and events can include user data, device data, environment data, data from sensors, sensor data, application data, implicit data, explicit data, etc. Inference, for example, can be employed to identify a specific context or action, or can generate a probability distribution over states of interest based on a consideration of data and events. Inference can also refer to techniques employed for composing higher-level events from a set of events and/or data. Such inference results in the construction of new events or actions from a set of observed events and/or stored event data, whether the events, in some instances, can be correlated in close temporal proximity, and whether the events and data come from one or several event and data sources. Various classification schemes and/or systems (e.g., support vector machines, neural networks, expert systems, Bayesian belief networks, fuzzy logic, and data fusion engines) can be employed in connection with performing automatic and/or inferred action in connection with the disclosed subject matter.

What has been described above includes examples of systems and methods illustrative of the disclosed subject matter. It is, of course, not possible to describe every combination of components or methods herein. One of ordinary skill in the art may recognize that many further combinations and permutations of the claimed subject matter are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

What is claimed is:

1. A system, comprising:
a processor; and
a memory that stores executable instructions that, when executed by the processor, facilitate performance of operations, comprising:
receiving a first indication of data availability corresponding to accessing first data via a first zone of a geographically diverse data storage system;
determining a data storage scheme based on the first indication of the data availability; and
storing a first chunk via the geographically diverse data storage system according to the data storage scheme.

2. The system of claim 1, wherein the geographically diverse data storage system has an asymmetric computing resource topography.

3. The system of claim 1, wherein the first indication of data availability is based on a first historical computing resource characteristic corresponding to the accessing the first data via the first zone of the geographically diverse data storage system.

4. The system of claim 1, wherein the storing the first chunk according to the data storage scheme results in a different count of chunks being stored via the first zone of the geographically diverse data storage system than by a second zone of the geographically diverse data storage system.

5. The system of claim 1, wherein the first chunk is selected from a group of chunks comprising a data chunk, a replicate data chunk, and a journal chunk.

6. The system of claim 1, wherein the operations further comprise adapting the data storage scheme based on a determined difference between a performance characteristic of the geographically diverse data storage system and a predicted performance characteristic of the geographically diverse data storage system, and wherein the predicted performance characteristic is based on the first indication of data availability.

7. The system of claim 1, wherein the operations further comprise receiving a second indication of data availability corresponding to accessing second data via a second zone of the geographically diverse data storage system, and wherein the determining the data storage scheme if further based on the second indication of the data availability.

8. The system of claim 7, wherein the second indication of data availability is based on a second historical computing resource characteristic corresponding to the accessing the second data via the second zone of the geographically diverse data storage system.

9. The system of claim 1, wherein the first indication of data availability is received from a first device located remotely from the geographically diverse data storage system.

10. The system of claim 1, wherein the first indication of data availability is received from a first device comprised in the geographically diverse data storage system.

11. The system of claim 1, wherein the first indication of data availability is received from a first device comprised in a second zone of a geographically diverse data storage system.

12. A method, comprising:
determining, by a system comprising a processor, a first availability value, wherein the first availability value is based on a time to access a first data stored via a first zone of a geographically diverse data storage system, and wherein the geographically diverse data storage system has an asymmetric computing resource topography;
selecting, by the system, a data storage scheme based on the first availability value; and
storing, by the system, a first chunk via the geographically diverse data storage system according to the data storage scheme.

13. The method of claim 12, wherein the determining the first availability comprises determining the first availability value is based on an average time to access the first data via the first zone.

14. The method of claim 12, wherein the determining the first availability comprises determining the first availability value is based on a moving-window average time to access the first data via the first zone.

15. The method of claim 12, wherein the determining the first availability comprises determining the first availability value further based on an anticipated occurrence of an event affecting computing resources corresponding to the first zone.

16. The method of claim 15, wherein the anticipated occurrence of the event affecting computing resources corresponding to the first zone is a scheduled maintenance, and wherein the computing resources is selected from a group of computing resources comprising a network resource, a processor resource, a memory resource, and a data storage resource.

17. A machine-readable storage medium, comprising executable instructions that, when executed by a processor, facilitate performance of operations, comprising:
determining a first availability value and a second availability value, wherein the first availability value is based on a time to access a first data stored via a first zone of a geographically diverse data storage system, wherein the second availability value is based on a time to access a second data stored via a second zone of the geographically diverse data storage system, and wherein the geographically diverse data storage system has an asymmetric computing resource topography;
determining a data storage scheme based on the first availability value and the second availability value; and
storing chunks via the geographically diverse data storage system according to the data storage scheme.

18. The machine-readable storage medium of claim 17, wherein the data storage scheme is proportionate according to a ratio of the first availability value to the second availability value, and where the storing the chunks is equal to or approximately equal to the ratio based on a first number of the chunks being stored via the first zone to a second number of the chunks being stored via the second zone.

19. The machine-readable storage medium of claim 17, wherein the storing the chunks comprises storing at least one journal chunk and at least one data chunk.

20. The machine-readable storage medium of claim 19, wherein the data storage scheme is modified in response to determining a threshold performance difference between a predicted performance of the geographically diverse data storage system and an actual performance of the geographically diverse data storage system, and wherein the predicted performance is based on the first availability value and the second availability value.
